(19) United States
(12) Patent Application Publication
(10) Pub. No.: US 2025/0201228 A1
(43) Pub. Date: Jun. 19, 2025

(54) STEERABLE ACOUSTIC WAVEGUIDE FOR TARGETED FOCUSED ULTRASOUND DELIVERY

(71) Applicant: VANDERBILT UNIVERSITY, Nashville, TN (US)

(72) Inventors: Daniel Solomon ESSER, Nashville, TN (US); Robert James WEBSTER, Nashville, TN (US); Eric John BARTH, Nashville, TN (US); Charles F. CASKEY, Nashville, TN (US); Marshal A. PHIPPS, Nashville, TN (US)

(21) Appl. No.: 18/982,030

(22) Filed: Dec. 16, 2024

Related U.S. Application Data
(60) Provisional application No. 63/610,592, filed on Dec. 15, 2023.

(51) Int. Cl. G10K 11/22; G10K 11/30

(52) U.S. Cl. CPC G10K 11/22; G10K 11/30

(57) ABSTRACT

A waveguide assembly for delivering focused acoustic energy includes a housing comprising a chamber filled with a medium for propagating acoustic waves. An acoustic transducer is supported the housing and has a surface facing into the chamber. The surface is configured to transmit acoustic waves into the chamber through the medium toward a focus zone. The waveguide assembly also includes structure configured to focus the acoustic waves transmitted from the surface of the acoustic transducer. The waveguide assembly further includes a flexible elongated waveguide having a first end positioned in the chamber opposite the curved surface, and a second end outside the chamber. The waveguide has a tubular configuration with an inner lumen in fluid communication with the chamber via the first end and being filled with the medium. The first end of the waveguide is configured to be positioned in the focus zone so that the focused acoustic waves are propagated through the medium in the inner lumen of the waveguide.

### RELATED APPLICATION

This application claims the benefit of U.S. Provisional Application Ser. No. 63/610,592, filed on Dec. 15, 2023, the disclosure of which is hereby incorporated by reference in its entirety.

### GOVERNMENT SUPPORT

This invention was made with government support under grant numbers R01 NS120518 and T32EB001628 awarded by the National Institute of Health. The government has certain rights in the invention.

### BACKGROUND

Current therapeutic ultrasound systems in research or clinical use typically consist of extra-corporeal ultrasound transducers or transducer arrays which are electronically steered to a target region, or translumenal devices which incorporate ultrasound transducers inside an ultrasound applicator that is placed inside of a natural orifice to deliver therapeutic ultrasound to a target location. Extracorporeal ultrasound application is challenging for regions of the anatomy surrounded by bony structures which will absorb a significant portion of the ultrasound energy before it reaches the target region. The size of translumenal devices is limited by the size of the transducer elements, which need to be quite large in order to generate sufficient power for therapeutic ultrasound treatment. Our invention locates the transducer outside of the body and employs a mechanically steerable waveguide to deliver the treatment to the region of interest.

### SUMMARY

A steerable acoustic waveguide is configured to deliver for delivery of interventional focused ultrasound to targets in confined spaces. The acoustic waveguide implements a steerable needle coupled to a transducer configured to focus the ultrasound waves so that they can be delivered to the target via the steerable needle. The steerable needle offers millimeter scale robotic control of the waveguide with high dexterity and navigability. The steerable acoustic waveguide facilitates targeted delivery of focused ultrasound. In a microscopy neuromodulation setup, the steerable acoustic waveguide can enable more flexible placement of the ultrasound transducer with the ability to guide the ultrasound output to a desired location in the tissue.

In an example configuration, a waveguide assembly for delivering focused acoustic energy includes a housing comprising a chamber filled with a medium for propagating acoustic waves. An acoustic transducer is supported the housing and has a surface facing into the chamber. The surface is configured to transmit acoustic waves into the chamber through the medium toward a focus zone. The waveguide assembly also includes structure configured to focus the acoustic waves transmitted from the surface of the acoustic transducer. The waveguide assembly further includes a flexible elongated waveguide having a first end positioned in the chamber opposite the curved surface, and a second end outside the chamber. The waveguide has a tubular configuration with an inner lumen in fluid communication with the chamber via the first end and being filled with the medium. The first end of the waveguide is configured to be positioned in the focus zone so that the focused acoustic waves are propagated through the medium in the inner lumen of the waveguide.

According to one aspect, the structure configured to focus the acoustic waves can include a curved surface of the acoustic transducer.

According to another aspect, the chamber can be further defined by the curved surface of the acoustic transducer.

According to another aspect, the housing can include a nose section having a tapered sidewall configuration. A portion of the chamber can be defined by the nose section and has a generally conical configuration.

According to another aspect, the structure configured to focus the acoustic waves can be configured to focus the acoustic waves into the conical portion of the housing.

According to another aspect, the structure configured to focus the acoustic waves can be configured to focus the acoustic waves at an angle configured so that the tapered sidewall of the nose section does not interfere with the waves.

According to another aspect, the nose section can include a tip through which an opening extends. The waveguide can extend through the opening to exit the housing. The tip can include a seal for forming a seal against the outer surface of the waveguide.

According to another aspect, the steerable waveguide can be constructed of a nickel titanium alloy.

According to another aspect, the steerable waveguide can have an inner diameter of 1-3 mm.

According to another aspect, the inner diameter of the waveguide can be chosen to ensure lossless propagation of the acoustic wave through the medium.

According to another aspect, the medium can be a fluid.

According to another aspect, the medium can be water, saline solution, mineral oil, a plastic material, or an epoxy material.

According to another aspect, the waveguide assembly can include one or more ports configured to circulate fluid through the chamber to provide cooling of the medium and to facilitate the removal of dissolved gasses in the medium filling the chamber and the waveguide.

According to another aspect, the housing can be constructed from a rigid plastic material that is acoustically matched to the medium and that has an absorption coefficient sufficiently high to cause residual acoustic energy to be absorbed and converted to thermal energy without causing excessive temperature increase in the housing plastic.

According to another aspect, the waveguide assembly can include a plastic sheath filled with pressurized air to act as an additional acoustic impedance barrier to limit the emission of acoustic energy from the steerable waveguide in high intensity applications.

According to another aspect, the structure configured to focus the acoustic waves can include one or more lenses.

According to another aspect, the lenses can include a focusing lens and a straightening lens. The focusing lens can be configured to focus the acoustic waves toward the straightening lens. The straightening lens can be configured to straighten the acoustic waves and direct the acoustic waves toward the focus zone.

According to another aspect, the focusing lens can be a concave lens and the straightening lens can be a convex lens.

According to another aspect, the structure configured to focus the acoustic waves can include a reflector.

According to another aspect, the reflector can include a concave focusing surface configured to focus the acoustic waves toward the focus zone.

According to another aspect, the reflector can include a concave focusing surface comprises a mirror surface.

According to another aspect, the first end of the waveguide can include a receiving surface having a surface area that is increased over that of a cross section of the waveguide distal of the first end. The first end of the waveguide can be configured to collect acoustic waves received via the receiving surface and to direct the collected acoustic waves along the length of the waveguide.

According to another aspect, a system for delivering focused acoustic energy can include the waveguide assembly according to any of the preceding aspects. The system can also include an actuator unit to which the waveguide assembly is operatively connected. The actuator can include a steerable outer tube structure through which the waveguide extends. The outer tube structure can include a tip portion that is actuatable to form a curve. The actuator unit can include an actuator that is manually actuatable to selectively form the curve in the tip portion and wherein waveguide follows the curve through the tip portion.

According to another aspect, a system for delivering focused acoustic energy can include the waveguide assembly according to any of the preceding aspects. The system can include a continuum robot to which the waveguide assembly is operatively connected. The continuum robot can include a concentric tube structure through which the waveguide extends. The concentric tube structure can be configured to be controlled robotically and can include an actuatable tip configured to form a bend when actuated. The waveguide can be configured to be delivered through the tip.

According to another aspect, the continuum robot can include a robotic control unit configured to impart translational and rotational movement to nested tubes of the concentric tube structure. The waveguide can be configured to pass through the continuum robot and the concentric tube structure with the tip of the waveguide passing through and projecting from the actuatable tip of the nested tube structure.

### DRAWINGS

FIG. 1 is a schematic illustration depicting a system for delivering focused ultrasound via a steerable acoustic waveguide, according to an example configuration.

FIG. 2 is a schematic illustration of a first example system implementing the steerable acoustic waveguide of FIG. 1.

FIG. 3 is a schematic illustration of a second example system implementing the steerable acoustic waveguide of FIG. 1.

FIG. 4 is a chart illustrating acoustic amplitude as a function of needle curvature of the steerable acoustic waveguide of FIG. 1.

FIG. 5 is a schematic illustration depicting a system for delivering focused ultrasound via a steerable acoustic waveguide, according to another example configuration.

FIG. 6 is a schematic illustration depicting a system for delivering focused ultrasound via a steerable acoustic waveguide, according to another example configuration.

FIG. 7 is a schematic illustration depicting an alternative configuration of a portion of the system that can be implemented in any of the example configurations described herein.

### DESCRIPTION

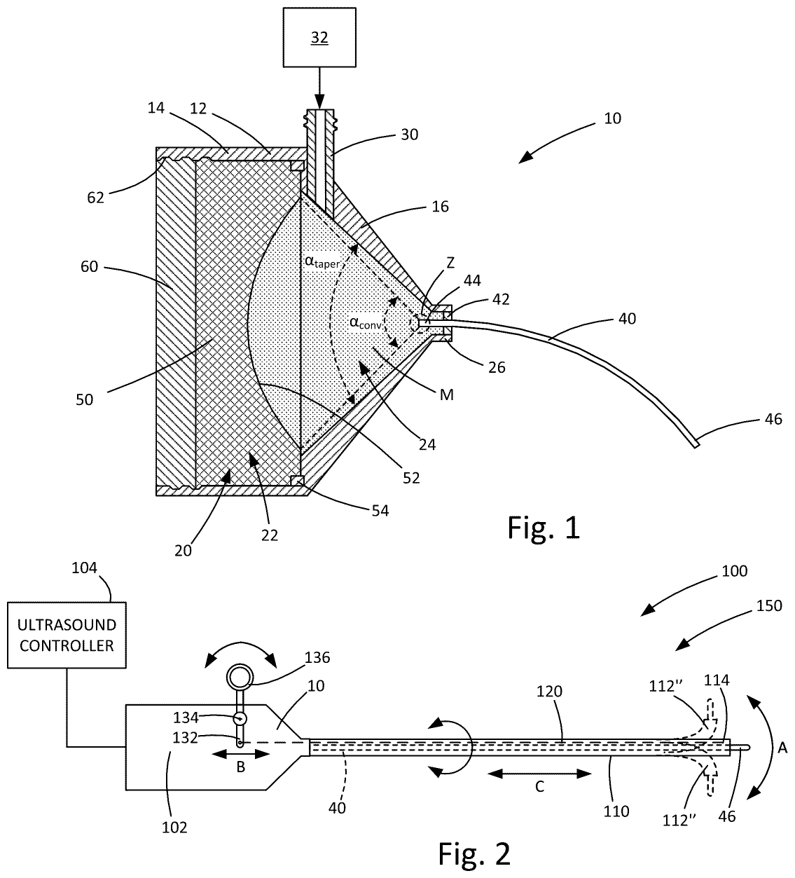

A waveguide assembly 10 is shown in FIG. 1. The waveguide assembly 10 includes a housing 12 having a sidewall 14 and a tapered nose section 16. In an example configuration, the sidewall 14 can be generally cylindrical and the nose section 16 can be generally conical. The housing 12 defines an interior space 20, with the sidewall defining a main chamber 22 and the nose section 16 defines a conical nose chamber 24. The nose section 16 has a tip 26 through which an opening extends and provides fluid communication with the nose chamber 24. One or more ports 30 provide fluid access to the nose chamber 24.

The waveguide assembly 10 also includes a steerable waveguide 40 that forms the steerable portion of the waveguide assembly. The steerable waveguide 40 is hollow, flexible elongated member having a needle-like configuration with an inner lumen having a small inner diameter that can, for example, be in the range of 1-3 mm. In an example construction, the steerable waveguide 40 can be constructed of a flexible nickel titanium alloy (Nitinol) tube. The inner lumen of the steerable waveguide 40 is filled with a medium having an acoustic impedance that contrasts from nitinol so that an acoustic wave introduced to the medium from the housing 12 will propagate along the length of the steerable waveguide through its inner diameter. Examples for the medium filling the steerable waveguide 40 are fluids, such as water, saline solution, or mineral oil, or other materials, such as plastics or an epoxy. The inner diameter of the steerable waveguide 40 is chosen to ensure lossless propagation of the acoustic wave through the medium.

The steerable waveguide 40 is secured to the housing 12 and enters nose section 16 through tip 26 where it passes through an X-ring seal 42 that, in conjunction with a fitting, such as a screw cap, forms a seal around the outer surface of the steerable waveguide 40. Through this connection, the inner diameter of the steerable waveguide 40 is fluidly connected with the nose chamber 24 of the housing 12.

The waveguide assembly 10 also includes an acoustic transducer 50 having a curved, e.g., parabolic transducer surface or face 52 configured to focus a generated acoustic wave into the nose chamber 24 toward the tip 26. The nose chamber 24 is filled with a medium M that is the same as the medium that fills the steerable waveguide 40. The medium-filled nose chamber 24 acoustically couples the acoustic transducer 50 with the medium-filled steerable waveguide 40. Together, the medium-filled nose chamber 24 and steerable waveguide 40 form the acoustic wave focusing and propagating portion of the waveguide assembly 10.

The housing 12 is configured to seal around the steerable waveguide 40 through the X-ring seal 42 and around the acoustic transducer 50, e.g., via a gasket or O-ring 54. A closure member 60, such as a plate, cap, or ring, can be connected to the housing 12 via threads or other fittings 62 to secure and seal the acoustic transducer 50 in the main chamber 22. In the assembled condition of FIG. 1, the medium-filled nose chamber 24 includes an adjacent volume defined by the focusing surface 52 of the acoustic transducer 50. The port(s) 30 allow the waveguide assembly 10 to be connected to a fluid circulation system 32 configured to provide cooling of the transducer 50 and to facilitate the removal of dissolved gasses in the medium M filling the nose-chamber 24 and the steerable waveguide 40.

The housing 12 can be constructed from a rigid plastic material. The closure member 60, when screwed into the housing, urges the acoustic transducer 50 against the gasket/O-ring 54 to seal the nose chamber 24 from the transducer end. At the same time, the X-ring seal 42 forms a seal around the steerable waveguide 40 at the tip 26 of the nose section 16. The screw-cap that compresses the X-ring seal 42 also secures the steerable waveguide 50 to the housing 12, particularly to the tip 26 of the nose section 16.

The focusing surface 52 of the acoustic transducer 50 has a curvature configured to produce a convergence angle α_{converge} at which generated acoustic waves are focused toward a focal point or zone Z. The conical configuration of the nose chamber 24 is selected to have a configuration and taper angle αₜₐₚₑᵣ selected avoid interference with the beam convergence angle α_{converge}. This ensures that the focal point of the transducer is within the nose chamber 24 so that high intensity ultrasound is not directly incident on the plastic housing.

The steerable waveguide 40 is supported by the tip 26 of the nose section 16 so that the proximal end 44 of the steerable waveguide is placed directly in the focal point/zone Z of the acoustic transducer 50. Acoustic energy focused on the focal point/zone Z enters the steerable waveguide 40 and propagates along the medium M in the waveguide. The focal point/zone Z can be positioned away from the tip 26 of the nose section 16, e.g., about 1 cm, to allow acoustic energy that does not enter the steerable waveguide 40 to disperse before being absorbed into the housing 12.

The housing 12, particularly the nose section 16, is constructed of a material that is acoustically matched to the medium M, so that the residual acoustic energy can be transmitted into the housing and absorbed, rather than reflected back to the transducer or other structures. The housing 12 is sufficiently thick, and the material used to construct it has an absorption coefficient sufficiently high to cause the residual acoustic energy to be absorbed and converted to thermal energy without causing excessive temperature increase in the housing plastic.

The steerable waveguide 40 is configured to be actuated by a secondary mechanism that allows for bending that allows the waveguide to be steered along a desired path during use. A first example configuration of a system 100 in which the waveguide assembly 10 can be employed is shown in FIG. 2. Referring to FIG. 2, the system 100 includes an actuator unit 102 to which the waveguide assembly 10 is operatively connected. An ultrasound controller 104 is operatively connected to the waveguide assembly 10 through the actuator unit 102. The ultrasound controller 104 controls the application of focused ultrasound energy via the waveguide assembly 10.

The actuator unit includes a steerable outer tube structure 110 through which the steerable waveguide 40 extends. The combination of the actuator unit 102, waveguide assembly 10, and outer tube structure 110 form a steerable ultrasound probe 150. The tip 46 of the steerable waveguide 40 extends from a steerable tip portion 112 of the outer tube structure 110. As shown in FIG. 2, the tip portion 112 is actuatable to form a bend, as indicated generally at 112′ and 112″, as indicated by curved arrow A. While bends are shown in opposite directions, it should be appreciated that the bend can be configured to be formed in a single direction, with the knowledge that and effective bending in the opposite direction can be achieved by rotating the steerable ultrasound probe 150 together as a unit.

The outer tube structure 110 is itself a flexible tube structure constructed, for example, of Nitinol, and can therefore bend in the same or a similar manner as the waveguide 40, so that the ultrasound probe 150 can be manipulated to a desired form or to follow a desired path. The stiffnesses of the tubes 40, 110 can be selected based on the type of procedure that the ultrasound probe 150 is intended to perform. Some procedures may require a greater degree of ultrasound probe 150 stiffness than others.

The tip portion 112 can be configured to bend in a variety of manners, an example of which is shown in FIG. 2. In this configuration, the tip portion 112 can be configured to bend in a bending plane in response to tension applied on a distal end 144 of the outer tube structure 110 by an actuation member 120, such as one or more cables. To produce this functionality, the tip 112 can have weakened sidewall portions that cause the bend to form in response to tension applied by the cable(s) 120.

To apply the actuation force at the tip portion 112 of the outer tube structure 110, the cable 120 can be connected to the tip at one end, and to an actuator 130 housed in the actuator unit 102. The actuator 130 can, for example, include a handle 132 having an end connected to the cable 120 and configured to pivot about a point 134 to cause the cable to extend/retract, as indicated generally by the arrow B. The handle 132 can include a grip 136, such as a thumb ring, for operating the handle while grasping the actuator unit 102.

In operation, the ultrasound probe 150 can be configured for gross movement by the user simply moving the unit in the XYZ space. At the same time, the steerable tip of the outer tube structure 110 can be actuated through the use of the actuator 102 to change the curved configuration of the tip 112, which includes the tip 46 of the steerable waveguide. Through a combination of gross system movement and tube curve actuation, the ultrasound probe 150 can be used to access portions of the anatomy heretofore inaccessible using conventional ultrasound transducers.

It is also possible that the axial position of the steerable waveguide 40 in the outer tube structure 110 can be adjusted, as indicated generally by arrow C, adding another degree of dexterity to the system 100. This can also allow for retraction of the waveguide tip 46 during tool delivery, and extension for ultrasound therapy application.

The system 100 can have alternative configurations for producing the actuatable bending of the tip portion 112. For example, instead of cables running parallel to the length of outer tube structure 110 and attached at the tip, flexible rods or rod-like mechanisms can be used.

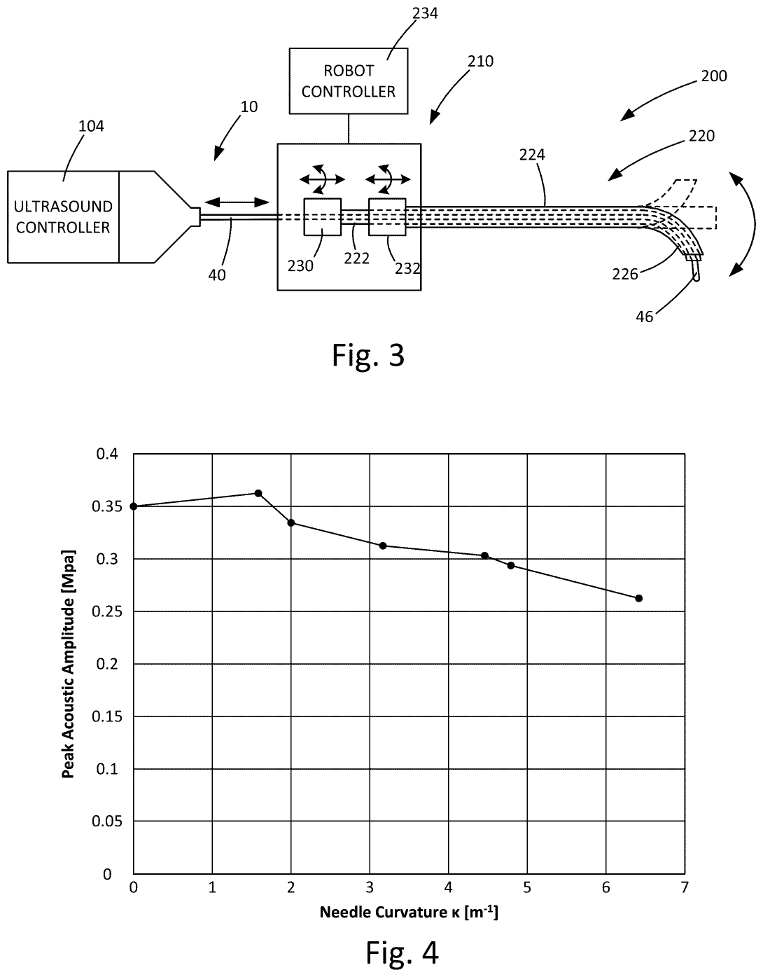

As another example, the steerable waveguide can be integrated with existing continuum robot designs that use a nitinol backbone as part of their elastic structure. This is shown in FIG. 3. As shown in FIG. 3, the system 200 includes a continuum robot 210 that includes a concentric tube structure 220. The concentric tube structure 220 includes an inner tube 222 and an outer tube 224 that are actuatable robotically through the use of associated actuators 230, 232. The actuators 230, 232 each are operable to impart one or both of rotation and axial translation to their associated concentric tubes 222, 224. A robot controller 234 controls the operation of the actuators 230, 232 to impart these movements.

Distal ends of the tubes 222, 224 are interconnected, forming an actuatable tip 226 of the concentric tube structure 220. The actuatable tip 226 is actuatable through relative translational movement of the tubes 222, 224 to form a bend 226. Depending on the configuration, the continuum robot 210 can be configured to produce one or more bends each having a desired bend radius, and each of which can be configured to bend independently or in combination.

The waveguide assembly 10 is operatively connected to a ultrasound controller 104. The ultrasound controller 104 controls the operation of the transducer 50 (see, FIG. 1) to transmit ultrasound waves via the steerable waveguide 40 to a target site in a patient.

As shown in FIG. 3, the system 200 has a pass-through configuration in which the steerable waveguide 40 of the waveguide assembly 10 passes through the continuum robot 210 and extends along the concentric tube structure 220 with the tip 46 passing through and projecting from the actuatable tip 226 of the robot.

In operation, the system 100 (FIG. 2) and the system 200 (FIG. 3) can be enclosed in a plastic sheath. This sheath can be filled with pressurized air to act as an additional acoustic impedance barrier to limit the emission of acoustic energy from the steerable waveguide 40 if necessary for high intensity applications.

Testing has shown that acoustic loss is linearly related to the curvature in the steerable waveguide 40. This loss factor can be calibrated for the specific design as it is expected to depend on the frequency, diameter, length, and other design choices regarding the overall system. The amplitude of the input RF wave used to drive the transducer will then be adjusted based on the estimate of the shape from the forward kinematics of the continuum robot, to ensure that the incident acoustic energy at the waveguide tip is controlled. The tip of the steerable waveguide may be open to the target environment, or it may contain an acoustic lens or reflector at the tip to change the output beam shape as it exits the waveguide.

Current therapeutic ultrasound systems in research or clinical use typically consist of extra-corporeal ultrasound transducers or transducer arrays which are electronically steered to a target region, or translumenal devices which incorporate ultrasound transducers inside an ultrasound applicator that is placed inside of a natural orifice to deliver therapeutic ultrasound to a target location. Extracorporeal ultrasound application is challenging for regions of the anatomy surrounded by bony structures which will absorb a significant portion of the ultrasound energy before it reaches the target region. The size of translumenal devices is limited by the size of the transducer elements, which need to be quite large in order to generate sufficient power for therapeutic ultrasound treatment.

Advantageously, the waveguide assembly 10 locates the transducer 50 outside of the body and employs the steerable waveguide 40 to deliver the treatment to the region of interest. The diameter of the waveguide 40 (e.g., 1-3 mm depending on design and frequency of ultrasound) can be made much smaller than devices that carry the transducer elements inside.

Accordingly, it will be appreciated that the waveguide assembly disclosed herein has numerous medical applications, including:
Natural orifice delivery of focused ultrasound in confined regions of the anatomy, such as:
Endonasal approach to the brain
Trans-foramen ovale approach to the brain.
Cardiothoracic applications around the spinal cord and ribs.
Transurethral procedures in the prostate and bladder.

The waveguide assembly 10 is advantageous over competing translumenal devices is the much smaller size of the steerable waveguide 40 as compared to devices that contain the focused ultrasound transducer elements within the transluminal device. The dramatic size reduction of the waveguide assembly 10, combined with the ability to mechanically steer the waveguide 40, makes it promising for a whole class of natural orifice focused ultrasound procedures that are currently not possible.

In testing, the transducer 50 was driven at 56 Vpp. A 2D beam map of the needle output was acquired, and the curvature was measured from a photo of the needle. It was found that the steerable waveguide 40 can deliver peak pressures in a therapeutically relevant range with a spot size normal to the beam axis of roughly 1.6 mm (FWHM). It was also found that the peak acoustic amplitude decreases linearly with bending, as shown in FIG. 4. This loss was 74% (339 kPa to 251 kPa) at the maximally curved configuration K=6.4 m⁻¹ which represents displacing the transducer end of the needle 20 mm from the straight configuration. The beam shape at the needle tip appears to remain circular; there is no statistically significant change in the FWHM or eccentricity of the acoustic field at the output.

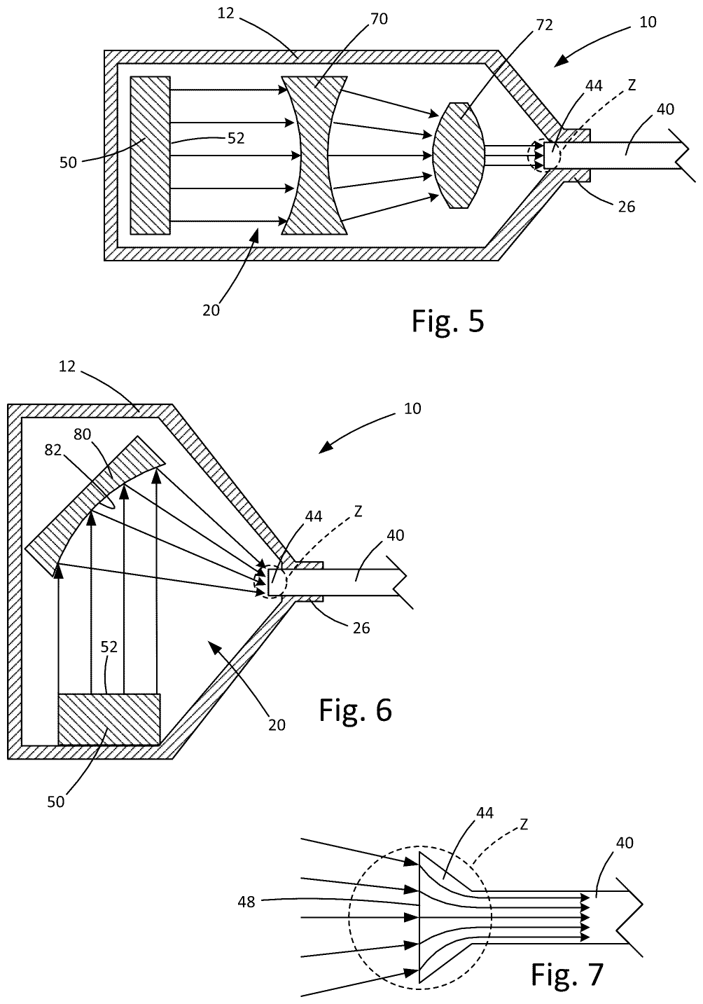

The waveguide assembly 10 can have alternative configurations, one of which is illustrated in FIG. 5. Referring to FIG. 5, the waveguide assembly 10 can include lenses 70, 72, supported in the chamber 20 of the housing 12, for focusing the acoustic waves generated by the transducer 50. In the example configuration of FIG. 5, the transducer 50 has a flat transmitting surface 52 which directs the acoustic waves generally linearly, as indicated by the arrows, toward the lenses 70, 72. The lenses 70, 72 focus the acoustic waves toward the focus zone Z at the proximal end 44 of the steerable waveguide 40. Specifically, lens 70 is a concave focusing lens that focuses the acoustic waves from the transducer 50 onto the lens 72, which is a convex straightening lens. The straightening lens 72 straightens the focused waves from the focusing lens 70 and directs the straightened waves into the proximal end 44 of the steerable waveguide 40.

As another alternative, instead of the flat transmitting surface 52 of the transducer 50, the example configuration of the waveguide assembly 10 shown in FIG. 5 could have transducer 50 configuration similar to that shown in FIG. 1, with a concave transmitting surface 52. In this example configuration, the transducer 50 would produce an initial focusing of the acoustic waves toward the lenses 70, 72. In this instance, the focusing lens 70 would further focus the waves toward the straightening lens 72, which would direct the waves toward the focus zone Z at the proximal end 44 of the steerable waveguide 40.

The waveguide assembly 10 can have another configuration, which is illustrated in FIG. 6. Referring to FIG. 6, the waveguide assembly 10 can include a reflector 80, supported in the chamber 20 of the housing 12, for focusing the acoustic waves generated by the transducer 50. In the example configuration of FIG. 6, the transducer 50 has a flat transmitting surface 52 which directs the acoustic waves generally linearly, as indicated by the arrows, toward the reflector 80. The reflector 80 has a concave reflecting surface 82 configured to redirect and focus the acoustic waves into the focusing zone Z at the proximal end 44 of the steerable waveguide 40.

As another alternative, instead of the flat transmitting surface 52 of the transducer 50, the example configuration of the waveguide assembly 10 shown in FIG. 6 could have transducer 50 configuration similar to that shown in FIG. 1, with a concave transmitting surface 52. In this example configuration, the transducer 50 would produce an initial focusing of the acoustic waves toward the reflector 80. In this instance, the reflector 80 would redirect and further focus the waves toward the proximal end 44 of the steerable waveguide 40.

As another alternative, any of the example configurations disclosed herein can include a steerable waveguide having a proximal end configured to improve its ability to collect and transmit acoustic waves along its length. As shown in FIG. 7, the steerable waveguide 40 can have a proximal end 44 with a tapered configuration configured to have receiving surface 48 with a surface area that is increased over that of the waveguide portions distal of the proximal end. The receiving surface 48 is configured to receive acoustic waves that are focused onto it, e.g., from the transducer 50 (FIG. 1), from the straightening lens 72 (FIG. 5), or the reflector 80 (FIG. 6). The proximal end 44 can be positioned in the focus zone Z to collect the acoustic waves and direct them from the receiving surface 48 to travel along the length of the steerable waveguide 40, as indicated generally by the arrows shown in FIG. 7.

From the above description of the invention, those skilled in the art will perceive improvements, changes and modifications. Such improvements, changes and modifications within the skill of the art are intended to be covered by the appended claims.

We claim:

1. A waveguide assembly for delivering focused acoustic energy, comprising:
a housing comprising a chamber filled with a medium for propagating acoustic waves;
an acoustic transducer supported the housing and having a surface facing into the chamber, the surface being configured to transmit acoustic waves into the chamber through the medium toward a focus zone;
structure configured to focus the acoustic waves transmitted from the surface of the acoustic transducer; and
a flexible elongated waveguide having a first end positioned in the chamber opposite the curved surface, and a second end outside the chamber, the waveguide having a tubular configuration with an inner lumen in fluid communication with the chamber via the first end and being filled with the medium;
wherein the first end of the waveguide is configured to be positioned in the focus zone so that the focused acoustic waves are propagated through the medium in the inner lumen of the waveguide.

2. The waveguide assembly recited in claim 1, wherein the structure configured to focus the acoustic waves comprises a curved surface of the acoustic transducer.

3. The waveguide assembly recited in claim 2, wherein the chamber is further defined by the curved surface of the acoustic transducer.

4. The waveguide assembly recited in claim 1, wherein the housing comprises a nose section having a tapered sidewall configuration, and wherein a portion of the chamber is defined by the nose section and has a generally conical configuration.

5. The waveguide assembly recited in claim 4, wherein the structure configured to focus the acoustic waves is configured to focus the acoustic waves into the conical portion of the housing.

6. The waveguide assembly recited in claim 5, wherein the structure configured to focus the acoustic waves is configured to focus the acoustic waves at an angle configured so that the tapered sidewall of the nose section does not interfere with the waves.

7. The waveguide assembly recited in claim 4, wherein the nose section comprises has a tip through which an opening extends, wherein the waveguide extends through the opening to exit the housing, and wherein the tip comprises a seal for forming a seal against the outer surface of the waveguide.

8. The waveguide assembly recited in claim 1, wherein the steerable waveguide is constructed of a nickel titanium alloy.

9. The waveguide assembly recited in claim 1, wherein the steerable waveguide has an inner diameter of 1-3 mm.

10. The waveguide assembly recited in claim 1, wherein the inner diameter of the waveguide is chosen to ensure lossless propagation of the acoustic wave through the medium.

11. The waveguide assembly recited in claim 1, wherein the medium comprises a fluid.

12. The waveguide assembly recited in claim 1, wherein the medium comprises water, saline solution, mineral oil, a plastic material, or an epoxy material.

13. The waveguide assembly recited in claim 1, further comprising one or more ports configured to circulate fluid through the chamber to provide cooling of the medium and to facilitate the removal of dissolved gasses in the medium filling the chamber and the waveguide.

14. The waveguide assembly recited in claim 1, wherein the housing is constructed from a rigid plastic material that is acoustically matched to the medium and that has an absorption coefficient sufficiently high to cause residual acoustic energy to be absorbed and converted to thermal energy without causing excessive temperature increase in the housing plastic.

15. The waveguide assembly recited in claim 1, further comprising a plastic sheath filled with pressurized air to act as an additional acoustic impedance barrier to limit the emission of acoustic energy from the steerable waveguide in high intensity applications.

16. The waveguide assembly recited in claim 1, wherein the structure configured to focus the acoustic waves comprises one or more lenses.

17. The waveguide assembly recited in claim 16, wherein the lenses comprise a focusing lens and a straightening lens, wherein the focusing lens is configured to focus the acoustic waves toward the straightening lens, and the straightening lens is configured to straighten the acoustic waves and direct the acoustic waves toward the focus zone.

18. The waveguide assembly recited in claim 17, wherein the focusing lens comprises a concave lens and the straightening lens comprises a convex lens.

19. The waveguide assembly recited in claim 1, wherein the structure configured to focus the acoustic waves comprises a reflector.

20. The waveguide assembly recited in claim 19, wherein the reflector comprises a concave focusing surface configured to focus the acoustic waves toward the focus zone.

21. The waveguide assembly recited in claim 20, wherein the reflector comprises a concave focusing surface comprises a mirror surface.

22. The waveguide assembly recited in claim 1, wherein the first end of the waveguide comprises a receiving surface having a surface area that is increased over that of a cross section of the waveguide distal of the first end, wherein the first end of the waveguide is configured to collect acoustic waves received via the receiving surface and to direct the collected acoustic waves along the length of the waveguide.

23. A system for delivering focused acoustic energy, comprising:
the waveguide assembly recited in claim 1; and
an actuator unit to which the waveguide assembly is operatively connected, the actuator comprising a steerable outer tube structure through which the waveguide extends, the outer tube structure comprising a tip portion that is actuatable to form a curve,
wherein the actuator unit comprises an actuator that is manually actuatable to selectively form the curve in the tip portion and wherein waveguide follows the curve through the tip portion.

24. A system for delivering focused acoustic energy, comprising:
the waveguide assembly recited in claim 1; and
a continuum robot to which the waveguide assembly is operatively connected, the continuum robot comprising a concentric tube structure through which the waveguide extends, the concentric tube structure being configured to be controlled robotically and comprising an actuatable tip configured to form a bend when actuated, wherein the waveguide is configured to be delivered through the tip.

25. The system recited in claim 24, wherein the continuum robot comprises a robotic control unit configured to impart translational and rotational movement to nested tubes of the concentric tube structure, and wherein the waveguide is configured to pass through the continuum robot and the concentric tube structure with the tip of the waveguide passing through and projecting from the actuatable tip of the nested tube structure.
